(19) United States
(12) Patent Application Publication
(10) Pub. No.: US 2011/0073824 A1
(43) Pub. Date: Mar. 31, 2011

(54) RAILING SYSTEM AND COUPLING ELEMENT AND METHODS OF ASSEMBLY

(76) Inventors: Rick A. Lappin, Locust, NC (US); Douglas Mancosh, Warwick, RI (US); Francis E. Loftus, Richboro, PA (US); Jim Fattori, Trevose, PA (US)

(21) Appl. No.: 12/891,177

(22) Filed: Sep. 27, 2010

Related U.S. Application Data
(60) Provisional application No. 61/245,802, filed on Sep. 25, 2009.
(60) Provisional application No. 61/369,440, filed on Jul. 30, 2010.

(51) Int. Cl. E04H 17/16; B23P 17/04

(52) U.S. Cl. 256/65.08; 29/428

(57) ABSTRACT

A connector for attaching a hollow baluster to a hollow rail in an extruded railing system includes two sections. A plug portion is adapted to be received in an end of the hollow baluster. A projection is adapted to be received in an aperture formed through a wall of the hollow rail. The projection may include a resilient tab configured to engage an interior surface of the hollow rail when received therein. In one embodiment, the plug portion and projection have axes that are not collinear and form an included angle. An outer taper of the plug portion allows for installation in stairway railing systems having ramp angles that deviate from the nominal.

### CROSS-REFERENCE TO RELATED APPLICATIONS

This application claims priority to and the benefit of U.S. Provisional Patent Application Ser. No. 61/245,802, filed on Sep. 25, 2009, and U.S. Provisional Patent Application Ser. No. 61/369,440, filed on Jul. 30, 2010, the disclosures of which are hereby incorporated by reference in their entireties.

### FIELD OF THE INVENTION

The invention relates generally to railing systems and, more specifically, to extruded railing systems that utilize specialized connectors to reduce substantially the need for conventional fasteners.

### BACKGROUND OF THE INVENTION

Railing systems are required by many building codes around decks and porches that are a certain height above the surrounding grade. For years, these railings were manufactured of wood or metal. With the advent of rigid plastics, however, these systems are now being manufactured of extruded hollow or solid polyvinyl chloride (PVC), composites of virgin polymer and recycled polymer waste, or other polymer compositions. Structurally, these systems usually include two vertical posts (usually wooden posts covered by plastic post sleeves) that provide anchoring structural support at either end of a length of railing. Secured near a bottom of the posts with a bracket, and spanning the distance between posts, is a lower rail that is substantially horizontal. Secured near the top of the posts with a bracket is a top rail that generally includes a retainer and a handrail secured thereto, which are usually parallel to the lower rail. A plurality of substantially parallel vertical balusters extend from the lower rail to the retainer. The balusters prevent children or large items from passing through the railing system and are often extruded or formed into straight, twisted, or other decorative shapes. The lower rail and top retainer connect to a top and bottom of each baluster with one or more screws that are screwed into the ends of each baluster. In constructions utilizing hollow balusters, a plug may be inserted into the hollow baluster to receive the screw and secure the baluster between the lower rail and the retainer. To hide the unsightly screw heads on the top retainer, a decorative handrail is slid onto the retainer to form the top rail.

Generally, the railing system is installed by first setting the wooden posts and sliding the post sleeves onto the posts. Next, the top and lower rails are cut to the appropriate length. Plugs are inserted into the top and bottom ends of the balusters and aligned with predrilled holes on each of the lower rail and the retainer. Screws inserted through the lower rail and retainer are used to secure the balusters in place. The handrail is then slid onto the top retainer, and a center support (if required due to railing length) is secured to the bottom side of the lower rail. The entire assembly is then placed between the posts, leveled, and the supporting brackets are then placed and marked. The entire assembly is then removed so the brackets may be secured to the post sleeves. Thereafter, the entire assembly is repositioned and the brackets are secured to the underside of the lower rail and the retainer. Additional screws are then used to secure the handrail to the retainer, from below. One exemplary embodiment of such a railing system is described in U.S. Pat. No. 6,702,259, the disclosure of which is hereby incorporated by reference herein in its entirety.

As is readily apparent from this description of the installation, the number of screws or other fasteners required to install such a railing system is considerable. For example, each baluster requires two screws for installation, and a number of screws must be installed through the retainer into the handrail. This number of screws, while necessary to ensure joining of parts and structural integrity, entails additional material cost and increases assembly labor, making such systems relatively expensive to install. What is needed then, is an extruded plastic railing system that reduces or even eliminates the need for threaded fasteners, while maintaining the structural integrity of railing systems that utilize them.

### SUMMARY OF THE INVENTION

In one aspect, the invention relates to a connector for attaching a hollow baluster to a hollow rail in an extruded railing system, the connector including a first section adapted to be received in an aperture formed in an end of the hollow baluster, and a second section adapted to be received in an aperture formed through a wall of the hollow rail, the second section having at least one resilient tab configured to engage an interior surface of the hollow rail when received therein. In an embodiment of the above aspect, the second section is sized and configured to preclude rotation of the connector relative to the rail when received therein. In another embodiment, the second section includes at least one projection, wherein the projection having a width and a thickness, wherein the width is greater than the thickness. In yet another embodiment, the resilient tab is a unitary part having two tines, each tine including a shoulder. In still another embodiment, the tines include a first, unstressed position and a second, deflected position.

In another embodiment of the above aspect, the shoulders contact an interior surface of the hollow rail when the tines are in the first, unstressed position. In another embodiment, the first section includes at least one raised ridge. In another embodiment, the connector includes at least one side surface and wherein the raised ridge projects from the side surface. In yet another embodiment, the raised ridge interacts with an interior surface of the hollow baluster, so as to form an interference fit between the baluster and the connector.

In another aspect, the invention related to a method of assembling a railing system including a first post, a second post, a hollow lower rail, a hollow upper rail, and a hollow baluster, the method including the steps of providing a first connector having a first section and a second section including at least one resilient tab, inserting the first section of the connector into the hollow baluster, and inserting the second section of the connector into an aperture formed in a wall of the hollow lower rail, so as to engage the resilient tab with an interior surface of the hollow lower rail. In an embodiment of the above aspect, the method includes providing a second connector having a first section, and a second section having at least one resilient tab, inserting the first section of the second connector into the hollow baluster, and inserting the second section of the second connector into an aperture formed in a wall of the hollow upper rail, so as to engage the resilient tab of the second connector with an interior surface of the hollow upper rail. In another embodiment, the method includes securing a first end of the hollow upper rail to the first post with a first upper bracket. In another embodiment, the method includes securing a second end of the hollow upper rail to the second post with a second upper bracket. In yet another embodiment, the method includes securing a first end of the hollow lower rail to the first post with a first lower bracket. In still another embodiment, the method includes the step of securing a second end of the hollow lower rail to the second post with a second lower bracket.

In another aspect, the invention relates to a connector for attaching a hollow baluster to a hollow rail in an extruded stairway railing system. The connector may include a projection defining a first longitudinal axis and adapted to be received in an aperture defined by a wall of a hollow rail, and a plug portion fixed to the projection, the plug portion defining a second longitudinal axis and adapted to be received in an aperture formed in an end of a hollow baluster, wherein the first longitudinal axis is not collinear with the second longitudinal axis. In one embodiment, the first longitudinal axis and the second longitudinal axis form an included angle. In another embodiment, the included angle is from about 2° to about 45°. In yet another embodiment, the included angle is from about 29° to about 35°. In still another embodiment, the included angle is about 32°.

In one embodiment, the plug portion includes a front face and a back face, and the front face is oriented at a front angle including an angle between the front face and an axis parallel to the first longitudinal axis, and the back face is oriented at a back angle including an angle between the back face and an axis parallel to the first longitudinal axis. In another embodiment, the front angle and the back angle are from about 2° to about 35°. In yet another embodiment, the front angle is less than the back angle. In still another embodiment, each of the front angle and the back angle deviate from the included angle by about 3°.

In one embodiment, the plug portion includes a side wall surface projecting in a direction substantially parallel to the first longitudinal axis. In another embodiment, the side wall surface includes a crush rib. In yet another embodiment, the connector includes an enlarged shoulder element located between the projection and the plug portion.

### DESCRIPTION OF THE DRAWINGS

Other features and advantages of the present invention, as well as the invention itself, can be more fully understood from the following description of the various embodiments, when read together with the accompanying drawings, in which:

FIG. 1 is an exploded schematic perspective view of a railing system in accordance with one embodiment of the invention;

FIGS. 2A and 2B are a schematic end view and a schematic perspective view of the lower rail of FIG. 1;

FIGS. 2C1-2C4 depict several schematic views of the lower bracket of FIG. 1;

FIG. 2D is a schematic end view of the lower bracket and lower rail combination of FIG. 1;

FIGS. 3A and 3B are a schematic end view and a schematic perspective view of the top hand rail of FIG. 1;

FIGS. 3C1-3C4 depict several schematic views of the upper bracket of FIG. 1;

FIG. 3D is a schematic end view of the upper bracket and top hand rail combination of FIG. 1;

FIG. 4A is a schematic perspective view of the baluster connector of FIG. 1;

FIG. 4B is a schematic sectional view of the baluster connector of FIG. 1;

FIG. 5 is a schematic sectional view of a baluster, connector, and top hand rail combination in accordance with one embodiment of the present invention;

FIG. 6 is a flowchart depicting one method of assembling the railing system of FIG. 1;

FIG. 7 is a schematic side view of an angled rail system, in accordance with one embodiment of the present invention;

FIG. 8 is a schematic side view of an angled baluster connector, baluster, and rail combination, in accordance with one embodiment of the present invention;

FIG. 9 is a schematic side view of the angled baluster connector of FIG. 8;

FIGS. 10A-10D depict several schematic views of the angled baluster connector of FIG. 8;

FIG. 11 is a schematic perspective view of the angled baluster connector of FIG. 8; and

FIGS. 12A and 12B are schematic side views of an angled baluster connector installed in a baluster, in accordance with one embodiment of the present invention.

### DETAILED DESCRIPTION

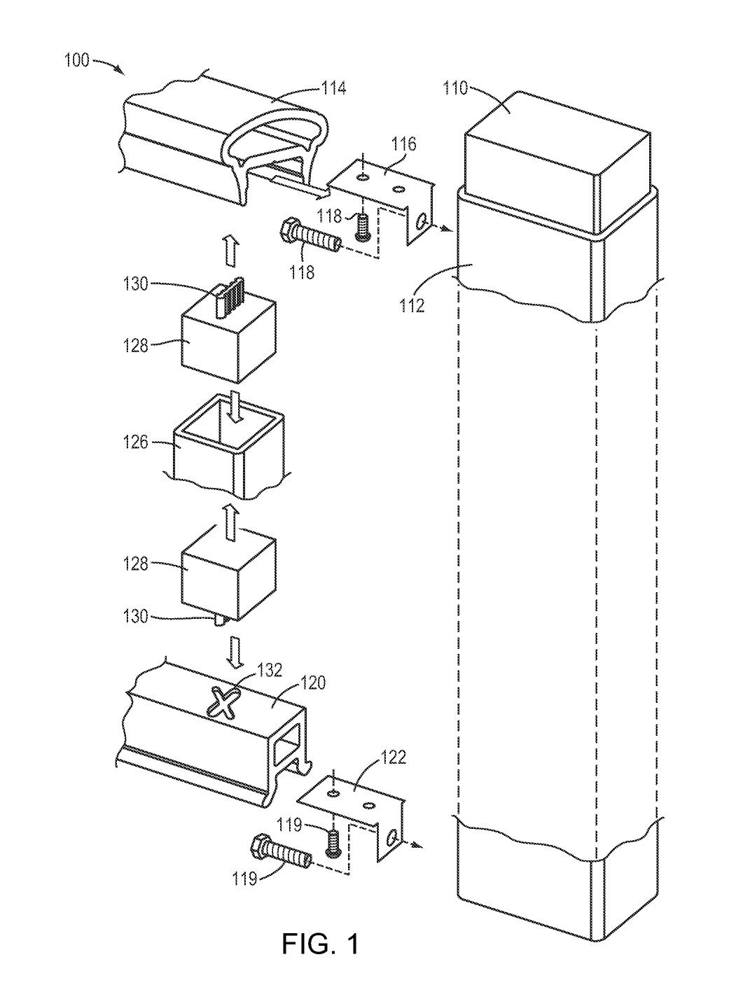

FIG. 1 depicts an exploded schematic view of a railing system 100 in accordance with one embodiment of the present invention. The system includes a 4″×4″ post 110 substantially vertically oriented. The base of the post 110 may be secured in or to a deck or porch structure with lag screws or bolts as know in the art. An extruded, hollow post sleeve 112 is inserted over the post, which may also be topped with a cap or other decorative feature. The system 100 also includes an upper rail 114 that may be extruded into virtually any decorative shape, and that is secured to the post 110 with an upper bracket 116 and one or more screws or bolts 118. The upper rail 114 provides a gripper surface for a person's hand when moving along the railing system, especially while ascending or descending stairs. One flange or leg of the upper bracket 116 and underside of the upper rail 114 are sized and configured so as to provide a close fit or an interference fit between the two elements. If additional security is required, one or more screws may be inserted through the bracket 116 into the underside of the upper rail 114, as depicted. The screw length is chosen to prevent the screw from penetrating through the top of the upper rail 114. A lower rail 120 is secured to the post 110 with a lower bracket 122 and one or more bolts or screws 118. Similar to the upper rail configuration, the underside of the lower rail 120 and a flange or leg of the lower bracket 122 are sized and configured to provide a close fit or an interference fit. Again, one or more screws 119 may be inserted through the lower bracket 122 and into the underside of the lower rail 120. The screw length is chosen to prevent penetration of the screw through the top of the lower rail 120.

A plurality of hollow balusters 126 join the upper rail 114 and the lower rail 120. A connector 128 is located at each end of each baluster 126. The connector 128 is sized and configured so as to provide a friction fit with the baluster 126, but other means of securing the two elements (e.g., adhesives), may be utilized alone or in addition. Projecting from the end of the connector 128 is a locking extension or element 130, described in more detail below. The locking extension 130 is sized and configured to mate with an upper opening in the bottom of the upper rail 114 (in the case of the upper connector) and a lower opening 132 in the top of the lower rail 120 (in the case of the lower connector). The upper opening and/or lower opening 132 may be formed during installation of the balusters 126 or machined or formed during manufacture of the upper and/or lower rails 114, 120.

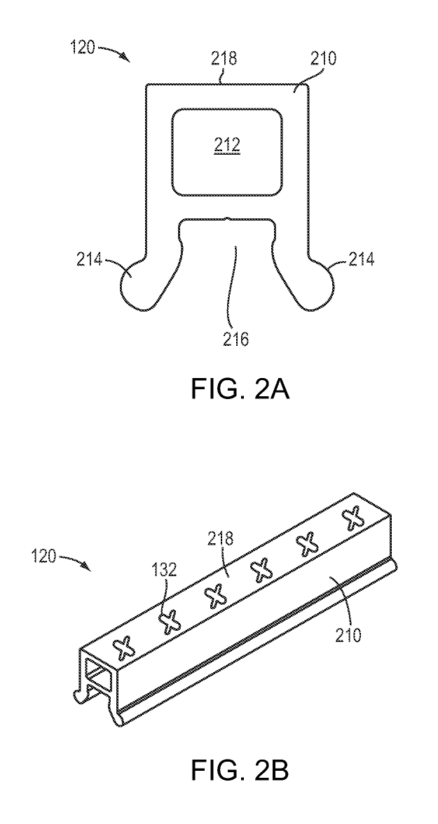

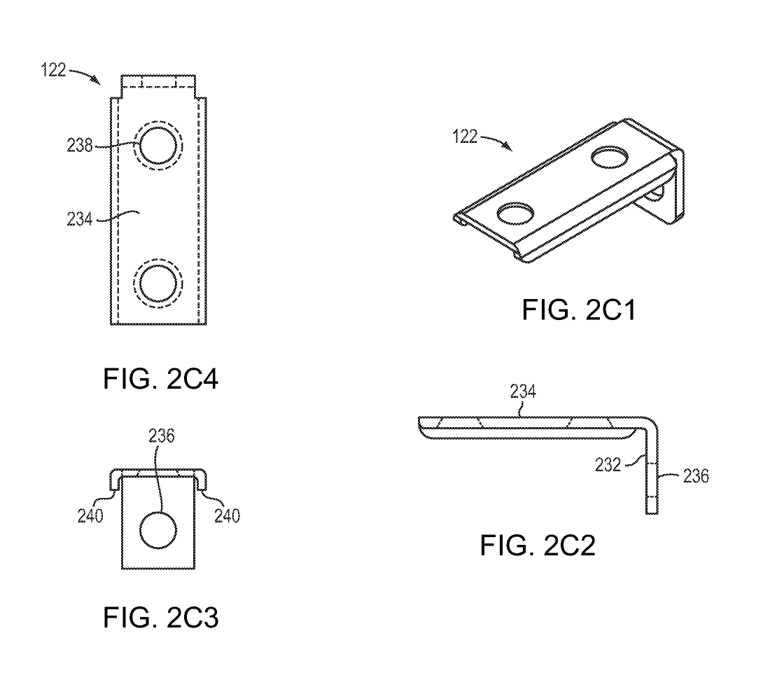

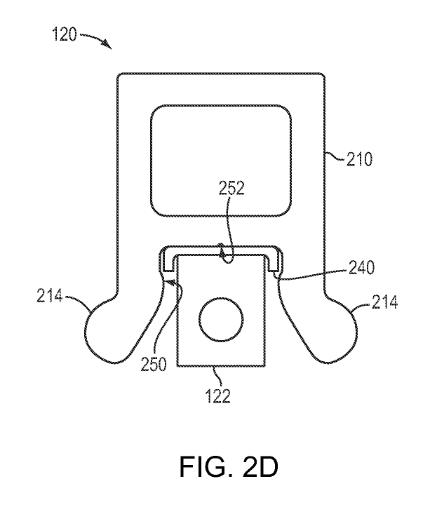

FIGS. 2A and 2B depict a lower rail 120, in accordance with one embodiment of the present invention. The lower rail 120 includes a lower rail profile 210 which may be virtually any desired shape. In the depicted embodiment, the lower rail profile 210 forms a lower rail void 212 with two lower rail extensions 214 projecting downward from the lower rail profile 210. The two lower rail extensions 214 may be forced or elastically deflected outward, so as to snap lock over the lower bracket 122 (described below) so that the lower bracket 122 is received into a lower rail recess 216 located between the two lower rail extensions 214. Alternatively, the lower bracket 122 can be slid into position from the end. A plurality of lower openings 132 are formed or machined in a top surface 218 of the lower rail profile 210, and are sized to receive the locking extension 130 of the baluster connectors 128 described below. The upper openings and lower openings 132 may be formed so as to allow multiple orientations of the balusters 126. For example, the lower openings 132 depicted in FIG. 2 allow for baluster connection in two angular positions. The lower openings 132 include a first elongate portion substantially orthogonal to a longitudinal axis of the lower rail 120, and a second elongate portion angled approximately 45 degrees from the axis of the lower rail 120.

The upper rail 114, lower rail 120, balusters 126, and connectors 128 may be made of any suitable solid material, such as polyvinyl chloride (PVC), blends of virgin polymer and recycled polymer waste, or other polymer compositions. Natural and/or man-made fibers or fillers may be included. Methods of forming the upper rail 114, lower rail 120, and balusters 126 include extrusion and injection molding. Connectors 128 may be formed typically by injection molding.

FIGS. 2C1-2C4 depict perspective, side, end, and top views of a lower bracket 122 in accordance with one embodiment of the present invention. The lower bracket 122 may be formed by known stamping methods and may be manufactured of a rigid metal such as aluminum, steel, stainless steel, etc., or made of a high strength polymer or reinforced fiber composite. The lower bracket 122 includes a lower post interface 232 and a lower rail interface 234. The lower post interface 232 includes one or more lower post holes 236 sized to receive a bolt, screw, or other connection element to secure the bracket 122 to the post 110. If screws are used to further secure the lower bracket 122 to the lower rail 120, the lower rail interface 234 includes one or more lower rail holes 238 sized to receive a bolt, screw, or other connection element. Lower bracket edges 240 of the lower rail interface 234 are radiused to facilitate spreading of the lower rail extensions 214 during installation. The radiused lower bracket edges 240 also interface with the lower rail extensions 214 to prevent rotation of the lower rail 120 once installed on the lower bracket 122.

FIG. 2D depicts a cross-sectional view of the lower rail 120 secured to the lower bracket 122. Notably, an inner portion of each lower rail extension 214 includes a lower protrusion 250 that is adapted to mate with the lower bracket edge 240 to prevent rotation once installed. Additionally, a lower channel 252 may be formed on the underside of the lower rail 120 that may mate with a raised protrusion on the lower rail interface 234 of the lower bracket 122. This channel/protrusion interface can also help locate and limit rotation of the lower rail 120 on the lower bracket 122, to prevent dislodgment of the lower rail 120.

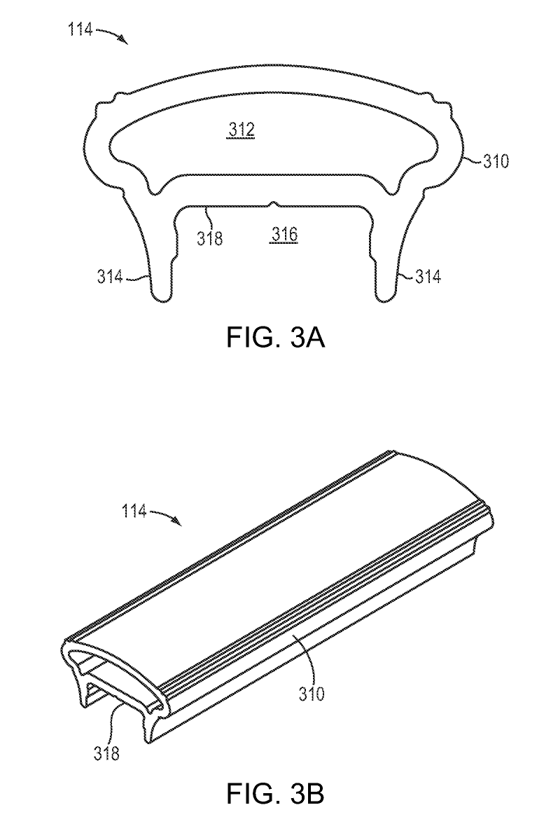

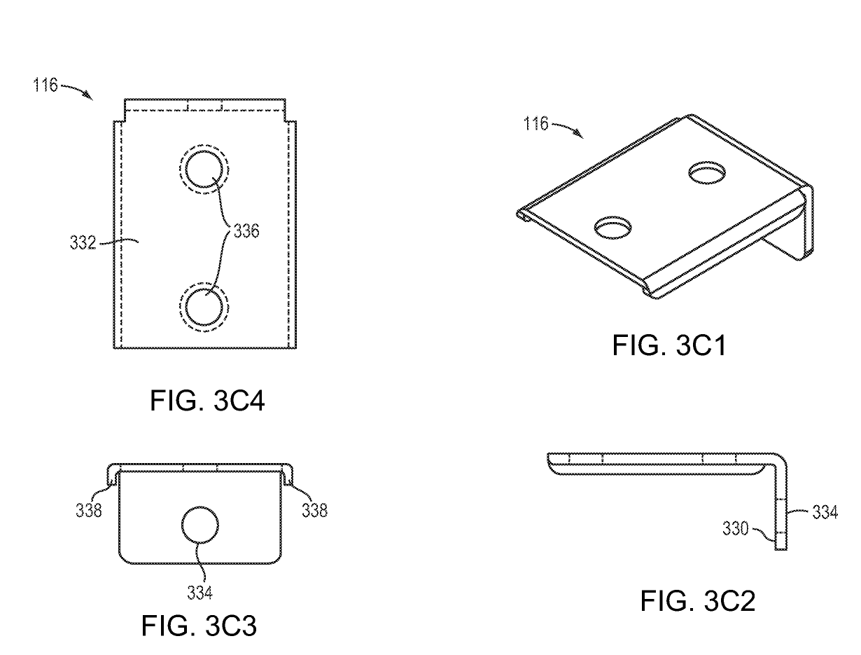

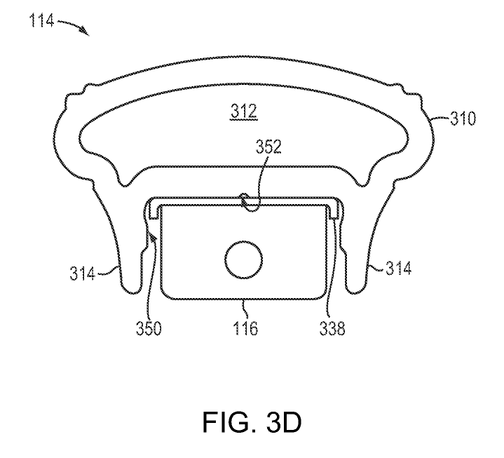

FIGS. 3A and 3B depict the upper rail 114, in accordance with one embodiment of the present invention. The upper rail 114 includes an upper rail profile 310, which may be virtually any desired shape. In the depicted embodiment, the upper rail profile 310 forms an upper rail void 312 with two upper rail extensions 314 projecting downward from the upper rail profile 310. The two upper rail extensions 314 may be forced or elastically deflected outward, so as to snap lock over the upper bracket 116 (described below) so that the upper bracket 116 is received into an upper rail recess 316 located between the two upper rail extensions 314. Alternatively, the upper bracket 116 can be slid into position from the end. A plurality of upper openings are formed or machined in a bottom surface 318 of the upper rail profile 310 in a similar manner to those in the lower rail profile 210, and are sized to receive the locking extension 130 of the baluster connector 128 described below.

FIGS. 3C1-3C4 depict perspective, side, end, and top views of the upper bracket 116 in accordance with one embodiment of the present invention. The upper bracket 116 may be formed by known stamping methods and may be manufactured of a rigid metal such as aluminum, steel, stainless steel, etc., or other methods and materials similar to the lower bracket 122. The upper bracket 116 includes an upper post interface 330 and an upper rail interface 332. The upper post interface 330 includes one or more upper post holes 334 sized to receive a bolt, screw, or other connection element to secure the bracket 116 to the post 110. If screws are used to further secure the upper bracket 116 to the upper rail 114, the upper rail interface 332 includes one or more upper rail holes 336 sized to receive a bolt, screw, or other connection element. Upper bracket edges 338 of the upper rail interface 332 are radiused to facilitate spreading of the upper rail extensions 314 during installation. The radiused upper bracket edges 338 also interface with the upper rail extensions 314 to prevent rotation of the upper rail 114 once installed on the upper bracket 116.

FIG. 3D depicts a cross-sectional view of the upper rail 114 secured to the upper bracket 116. Notably, an inner portion of each upper rail extension 314 includes an upper protrusion 350 that is adapted to mate with the upper bracket edges 338 to prevent rotation once installed. Additionally, an upper channel 352 may be formed on the underside of the upper rail 114 that may mate with a raised protrusion on the upper rail interface 332 of the upper bracket 116. This channel/protrusion interface may also help locate and limit rotation of the upper rail 114 on the upper bracket 116, to prevent dislodgment of the upper rail 114. The interface also allows the upper bracket 116 to be installed directly to the upper channel 352 (i.e., without an intervening retainer, as typically required in prior art railing systems).

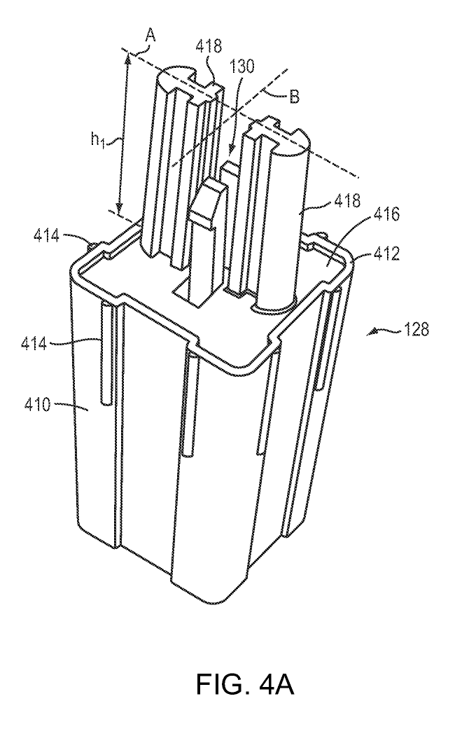

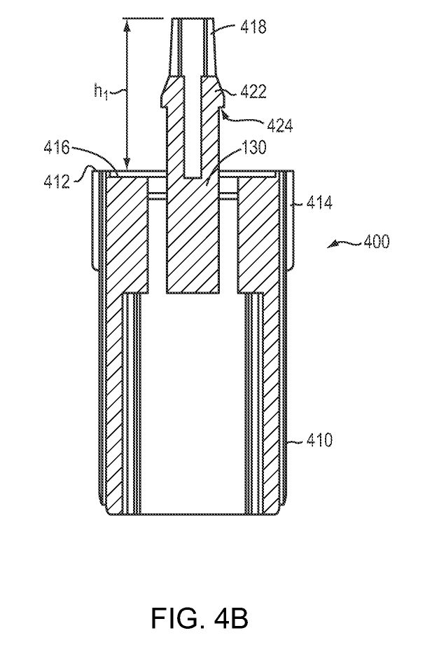

FIG. 4A depicts the connector 128 in accordance with one embodiment of the present invention. FIG. 4B is a schematic sectional view of the connector 128 along a first axis A, depicted in FIG. 4A. The connector 128 includes a first plug portion 410 that is sized and configured to fit within the end of a hollow baluster 126. When inserted into the baluster 126, it is desirable that a top edge 412 of the connector 128 does not extend substantially below the terminal end of the baluster 126. This may be achieved in several ways. In one embodiment, the dimensions of the plug portion 410 may increase slightly as they approach the top edge 412, such that an interference fit is obtained as the top edge 412 becomes approximately even with the terminal end. In another embodiment, the dimensions of the plug portion 410 may be substantially uniform, but the plug 410 may include one or more plug ridges 414 that project further from the side of the plug portion 410 as they approach the top edge 412, as shown in FIG. 4A. In yet another embodiment, the top edge 412 may be flared or include an enlarged edge to prevent insertion of the plug portion 410 past the top edge 412.

Extending upward from a top surface 416 of the plug portion 410 is a second portion comprising one or more projections 418, which are formed as a unitary part with the plug portion 410 of the connector 128, in the depicted embodiment. The projections 418 are symmetrical along first axis A and a second orthogonal axis B of the connector 128. The projections 418 have a projection height h₁ that is less than a depth of each of the lower rail void 212 and the upper rail void 312. Similar to the tapered dimensions of the plug portion 410, described above, the projections 418 may also taper (from wide to narrow as the height above the top surface 416 increases) so as to provide an interference fit of the projection 418 with the upper opening or the lower opening 132, when fully inserted. This taper also facilitates manufacture of the connector 128 by injection molding. The connector 128 also includes one or more locking extensions or elements 130, which, in this embodiment, are a pair of resilient tabs. Each tab includes a tine 422 and a hook or shoulder portion 424. The distance from the top surface 416 of the plug portion 410 to the shoulder 424, in certain embodiments, corresponds generally to a thickness of the extruded material of the upper and lower rails 114, 120. Therefore, when the projection 418 and tabs are inserted into the upper opening or lower opening 132, the tabs will deflect until they are passed completely through the material. At this point, the shoulder portion 424 will pass the material edge, the tine 422 will return to its unstressed position, and the connector 128 will be secured to the rail.

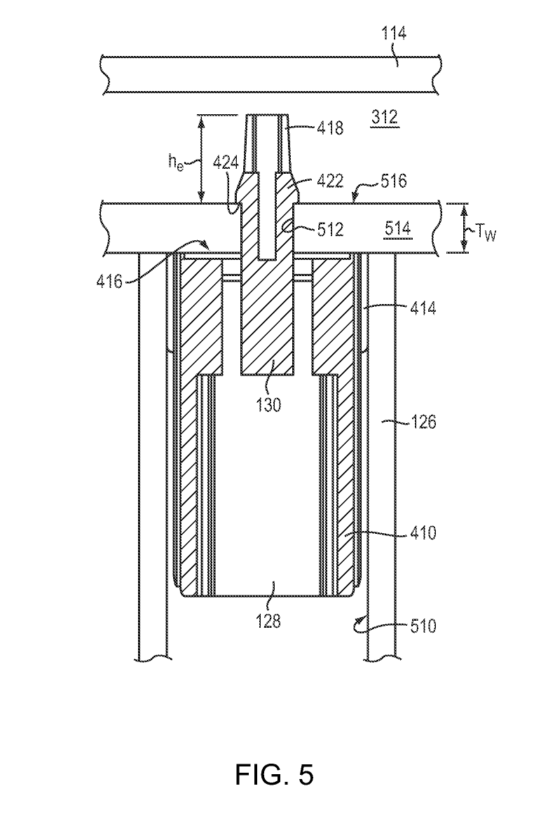

This configuration is depicted in FIG. 5, which is a schematic sectional view of the connector 128 along the first axis A, as installed in the upper rail 114 of the railing system 100. To install the connector 128 in the railing system 100, the first section, or plug portion 410, is first inserted into a first end of the hollow baluster 126. The plug portion 410 is dimensioned to fit within the baluster 126, and plug ridges 414 located near the top of the plug portion 410 form an interference fit between the plug portion 410 and an interior surface 510 of the baluster 126. This interference fit prevents inadvertent pull-out of the connector 128 once installed. In the depicted embodiment, the top surface 416 of the plug portion 410 is substantially flush with the terminal end of the baluster 126. In other embodiments, the top surface 416 may be located above or below the terminal end of the baluster 126. A flush configuration, however, may be more visually appealing and may prevent the ingress of dirt, water, snow, etc.

The second section of the connector 128 includes two projections 418, which are inserted into an upper opening 512 in a lower wall 514 of the upper rail 114. As the projections 418 are inserted, the tines 422 of the locking element 130 also penetrate the upper opening 512. In the depicted embodiment, the locking element 130 is a unitary element having two flexible tines 422. During insertion, the tines 422 deflect from their neutral, unstressed position to a deflected position. In the deflected position, the two tines 422 move closer to each other and, in certain embodiments, the facing surfaces of the tines 422 may contact. Once the shoulders 424 of the tines 422 pass an interior surface 516 of the lower wall 514 of the top railing 114, the tines 422 return to their neutral, unstressed position. In certain embodiments, this return motion may be accompanied by an audible “click.” Once returned to their neutral position, the shoulders 424 of the tines 422 engage with the interior surface 516 of the wall 514, thereby preventing inadvertent pull-out of the connector 128 from the upper opening 512. An exposed height hₑ of the projection 418 (i.e., the height of the projection 418 that extends above the interior surface 516 of the railing lower wall 514) is based at least in part on the total height within the upper rail void 312. Generally, it is desired that the exposed height hₑ be less than the height of the upper rail void 312, although flexible projections 418 that bend when contacting the opposite surface of the upper rail 114 may be utilized.

As depicted, it is generally desirable that the distance from the top surface 416 of the plug portion 410 to the shoulder 424 be substantially similar to or slightly greater than a thickness T_{w} of the wall 514 of the upper rail 114, although this is not required. Similarity between these two dimensions, however, may minimize play between the baluster 126 and the upper rail 114, as well as prevent the ingress of contaminants. Additionally, while FIG. 5 depicts the interface between the baluster 126 and the upper rail 114, the interface between the baluster 126 and the lower rail 120 is similar.

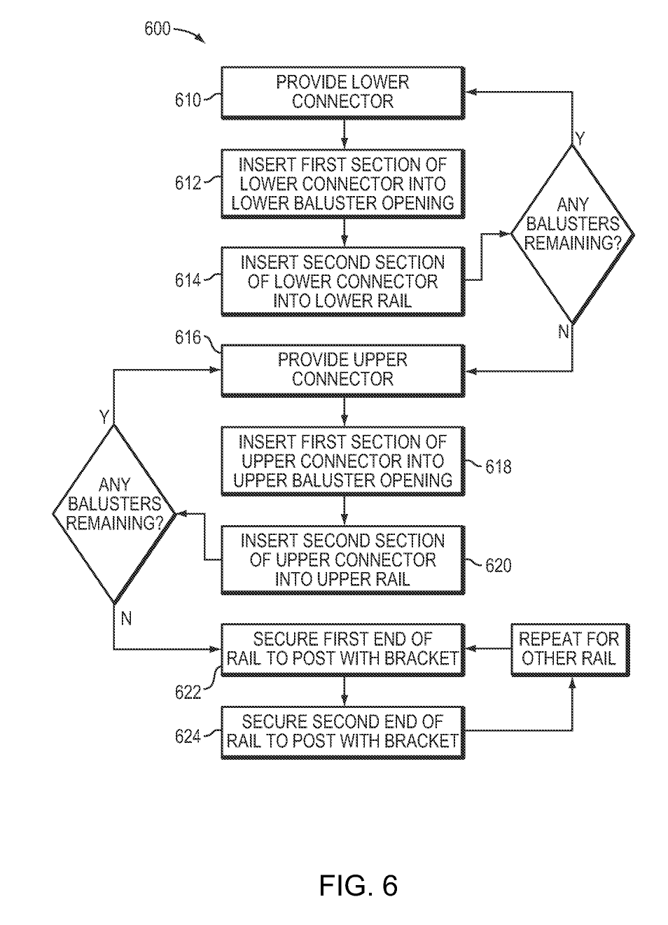

FIG. 6 depicts a method 600 of assembling the railing system 100 in accordance with one embodiment of the present invention. In the depicted method 600, the terms “upper” and “lower” are used to describe different rails, balusters, connectors, and portions thereof. For these purposes, these terms are generally interchangeable. That is, while the depicted order of this method first describes connecting a lower rail and a lower portion of a baluster with a lower connector, alternative methods may include first connecting an upper rail and an upper portion of a baluster with an upper connector. To assemble the railing system 100, the upper and lower rails 114, 120 are first cut to fit between two posts 110, which may also be predrilled and fitted with brackets to ensure proper rail length. The connector 128 as described herein is provided (step 610) to connect the balusters 126 to the upper and lower rails 114, 120. The first or plug section 410 of the connector 128 is then inserted (step 612) into a lower opening of the hollow baluster 126. A second section of the connector 128 (containing projections 418 and locking elements 130) is then inserted (step 614) into the lower opening 132 in the lower rail 120, until the locking elements 130 engage with the interior surface 516 of the lower rail 120. In the depicted embodiment, the above steps may be repeated until all balusters 126 for a given length of rail are secured to the lower rail 120, via the connectors 128. Once all of the balusters 126 are connected to the lower rail 120, the opposite ends of the balusters 126 may be connected to the upper rail 114.

Connection of upper portions of the balusters 126 to the upper rail 114 begins with providing (step 616) the connector 128 and inserting (step 618) the first or plug end 410 into an upper portion of the hollow baluster 126. The second section of the connector 128 (containing the projections 418 and locking elements 130) is then inserted (step 620) into the upper opening 512 in the upper rail 114, until the locking elements 130 engage with the interior surface 516 of the upper rail 114. These steps are repeated until all of the balusters 126 for a given length of rail are secured to the upper rail 114. Once the length of upper rail 114 is connected to the length of lower rail 120 via the balusters 126, a first end of either the upper rail 114 or lower rail 120 is secured (step 622) to one of the posts 110. This is followed by securing (step 624) a second end of the rail to a second post 110. These steps are again repeated for the other rail. In addition to the assembly variations described above, other variations to the method 600 are also contemplated.

For example, the upper and lower rails 114, 120 may first be cut and the upper and lower brackets 116, 122 may be secured to the posts. Thereafter, one of the rails, e.g., the lower rail 120, may be secured to the posts 110 with the brackets, then the lower connectors 128 may be used to secure the balusters 126 to the lower rail 120. Thereafter, the upper connectors 128 may be inserted into the hollow balusters 126, then secured to the upper rail 114, which is then secured to the posts 110. In another embodiment, the upper and lower connectors 128 may be inserted into both ends of all of the balusters 126, then secured to the upper and lower rails 114, 120. Other methods and acceptable orders in which to assemble the various railing system components are also contemplated.

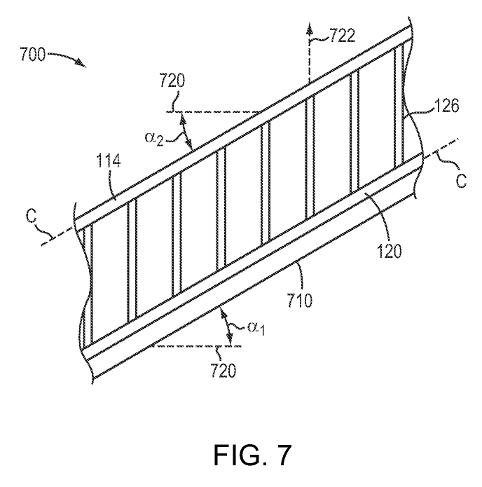

FIG. 7 is a schematic side view of a stairway railing system 700 installed along a stairway or a ramp 710, in accordance with one embodiment of the present invention. In a typical ramp or stairway installation, the ramp or stairway 710 is oriented at a ramp angle α₁ with respect to a horizontal direction 720. The upper rail 114 and lower rail 120 are substantially parallel and define a rail longitudinal axis C. Rail longitudinal axis C is oriented at a rail angle α₂, with respect to horizontal 720, that is generally equal to the ramp angle α₁. Balusters 126 between the upper and lower rails 114, 120 are substantially aligned with a vertical direction 722.

The rail angle α₂ may be between about one degree and about 45 degrees, or more, depending on the application. For example, ramps 710 that are compliant with the Americans with Disabilities Act (ADA) have a rail angle α₂ of about five degrees. In typical stair installations, the rail angle α₂ is between about 29 degrees and about 35 degrees, or generally about 32 degrees. Other rail and ramp angles α₁, α₂ may be utilized, depending on the desired or required application.

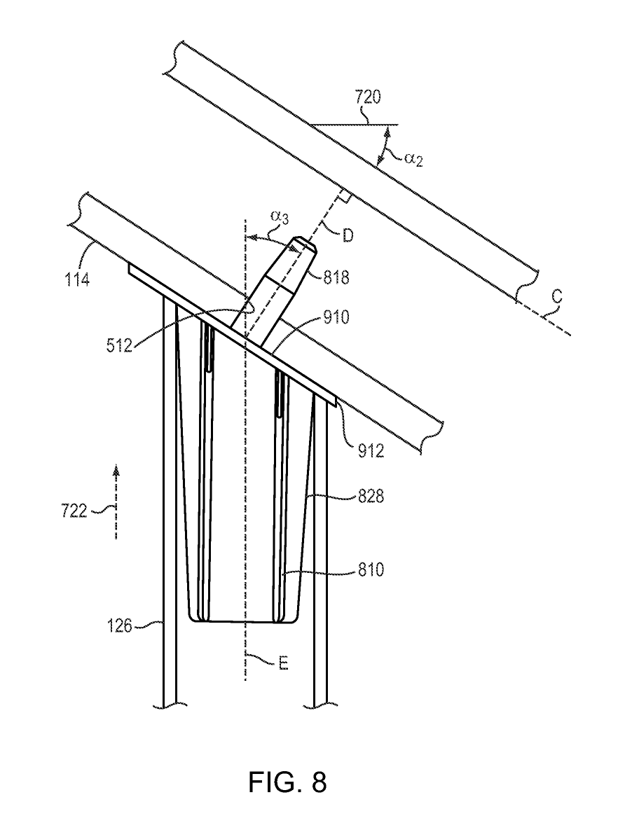

As depicted in FIG. 8, in one embodiment, the baluster to rail connector is an angled connector 828 connecting an upper rail 114 and a baluster 126, along a ramp or stairway 710. Installation of the angled connector 828 between a lower rail 120 and the baluster 126 is similar. Referring to FIG. 8, to connect vertically oriented balusters 126 to the sloped lower rail 120 and upper rail 114, the projection 818 of the angled connector 828 extends into the upper rail 114 or the lower rail 126 in a direction perpendicular to the rail longitudinal axis C. The plug portion 810 of the angled connector 828 extends into the baluster 126 in the vertical direction 722. As described above, the upper rail 114 and lower rail 120 include one or more upper openings 512 and lower openings 132, respectively, to accommodate the projection 818. Similarly, the baluster 126 may be hollow or include an aperture to receive the plug portion 810.

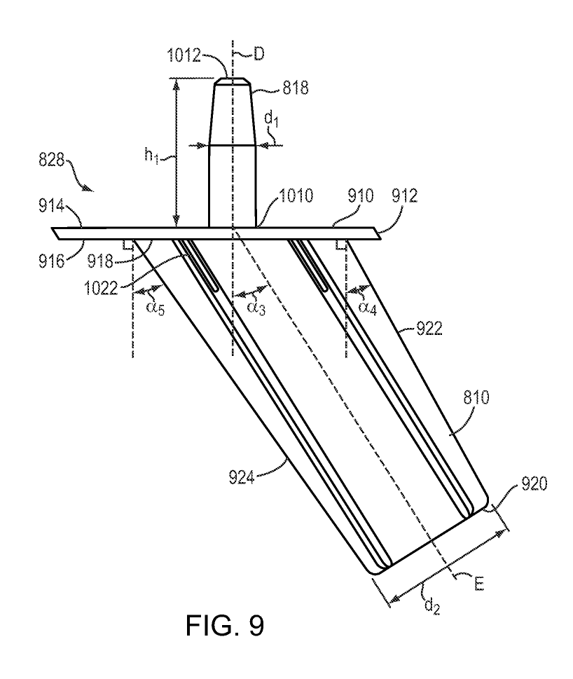

FIG. 9 is a schematic side view of the angled connector 828, in accordance with one embodiment of the present invention. In the angled connector 828, depicted in FIGS. 8 and 9, the projection 818 extends along a first longitudinal axis D, the plug portion extends along a second longitudinal axis E, and the first longitudinal axis D is not collinear with the second longitudinal axis E. An included angle α₃ is the angle between the first longitudinal axis D and the second longitudinal axis E. The projection 818 and the plug portion 810 are connected at an interface 910. In the depicted embodiment, the interface 910 includes an enlarged shoulder element 912 located between the projection 818 and the plug portion 810. The shoulder element 912 may be a flat plate or sheet, or a portion thereof, having a top side 914 and a bottom side 916, and the projection 818 may extend from the top side 914 and the plug portion 810 may extend from the bottom side 916. The shoulder element 912 helps prevent torsional deflection or bending of the upper rail 114 or lower rail 120 at the connection point of the baluster 126. Prevention of such deflection or bending may be particularly desirable for the upper rail 114, which is subject to direct loading by hands of users of the stairs or ramp.

In the depicted embodiment, the plug portion 810 has a plug depth d₂ that is largest at a plug base 918 closest to the projection 818, and smallest at a plug end 920, at the opposite end of the plug 810. In certain embodiments, the plug depth d₂ defines a distance between a front face 922 and a back face 924 of the plug portion 810. A front angle α₄ is the angle formed between the front face 922 and an axis parallel to the first longitudinal axis D. Similarly, a back angle α₅ is the angle formed between the back face 924 and an axis parallel to the first longitudinal axis D. To achieve the depicted taper, the front angle α₄ is generally less than the included angle α₃, which is in turn generally less than the back angle α₅.

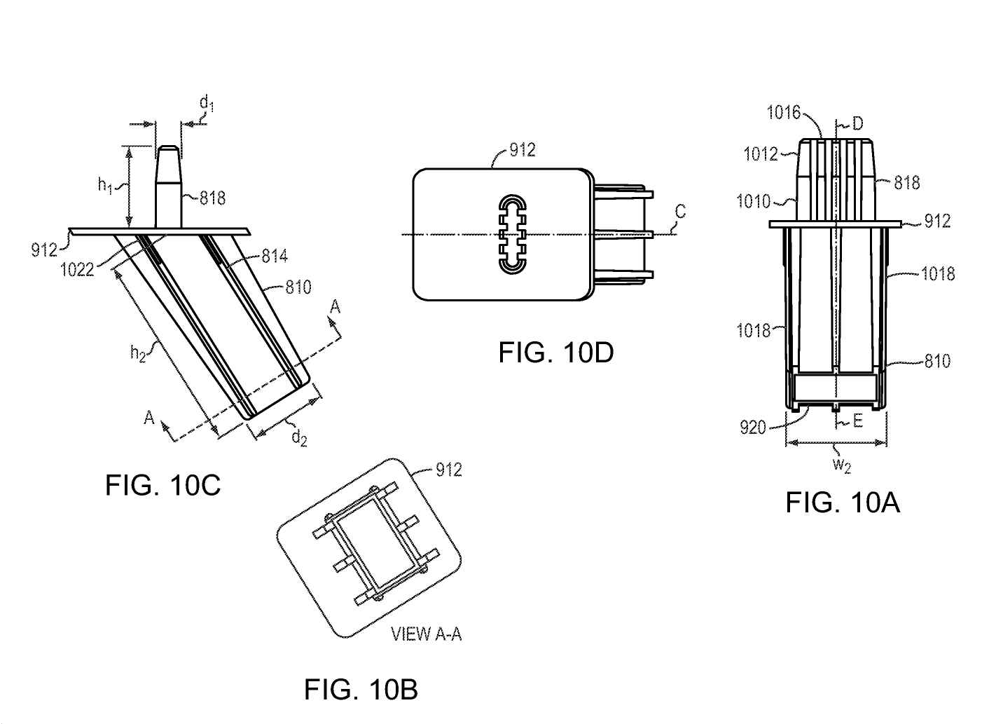

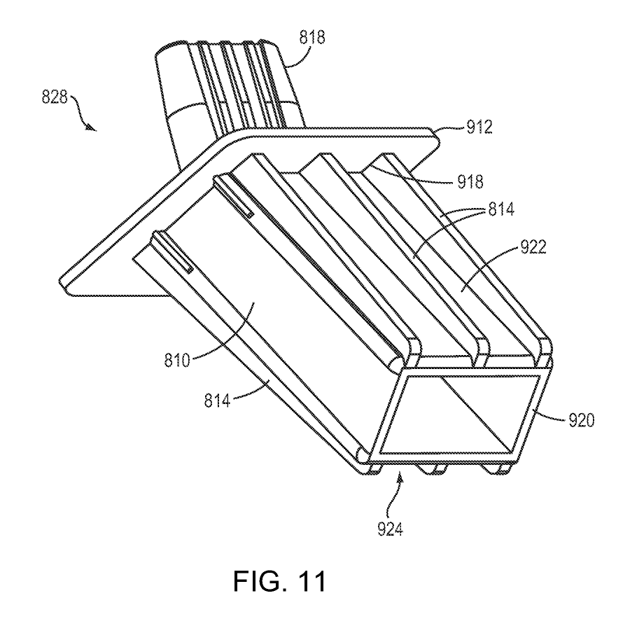

FIGS. 10A-10D depict several views of the angled connector 828 of FIG. 8, in accordance with one embodiment of the present invention. The projection 818 is dimensioned to provide a secure connection with the upper and lower rails 114, 120. For example, the projection height h₁ may be chosen to provide sufficient penetration of the projection 818 into the upper and lower rails 114, 120. Similarly, a projection depth d₁ may be chosen to provide a tight interference fit with the upper and lower rails 114, 120. The projection 818 may also be tapered (i.e., thicker at a projection base 1010 and narrower at a projection tip 1012) for ease of manufacture and/or insertion of the projection 818 into the upper and lower rails 114, 120.

At any given distance along the first longitudinal axis D, the projection 818 may have any cross-sectional shape, including circular, square, rectangular, polygonal, oval, triangular, or any combination thereof. In one embodiment, the cross-section of the projection 818 is approximately rectangular. The projection 818 may also include one or more projection ridges 1016 along one or more of the sides of the projection 818 that provide an interference fit with the upper opening 512 or lower opening 132. In addition, as described above with regard to FIG. 5, the projection 818 may include a locking element 130 that prevents inadvertent pull-out of the angled connector 828 from the upper rail 114 or the lower rail 120.

The plug portion 810 is dimensioned to provide a secure connection within the baluster 126. The plug portion 810 has a plug length h₂ that extends from the plug base 918 to the plug end 920. In addition, at any given distance between the plug base 918 and the plug end 920, along the second longitudinal axis E, the plug portion 810 may have any cross-sectional shape. For example, the cross-section of the plug portion 810 may be circular, square, rectangular, polygonal, oval, triangular, or any combination thereof. In the depicted embodiment, the cross-section of the plug portion 810 is approximately square and is tapered from the plug base 918 to the plug end 920. Each side taper may be from about one degree to about ten degrees off of an axis parallel to the second longitudinal axis E. In the depicted embodiment, each taper angle is about three degrees. A plug width w₂ of the plug portion 810 is substantially constant from the plug base 918 to the plug end 920. In other embodiments, the plug portion 810 is tapered so that the plug width w₂ decreases, along the second longitudinal axis E, from the plug base 918 to the plug end 920. As described above, the taper may facilitate manufacture of the angled connector 828 and/or insertion of the plug portion 810 into the baluster 126. In one embodiment, plug sides 1018 of the plug portion 810 include plug ridges 814 that extend along the plug length h₂. The plug ridges 814 may help secure the plug portion 810 to the baluster 126 by providing an interference fit. The plug ridges 814 may also include one or more crush ribs 1022 that deform upon insertion into the baluster 126.

In some embodiments, to achieve a tapered plug portion 810, the difference between the front angle α₄ and the back angle αₛ is between about one degree and about 30 degrees. In other embodiments, the difference between the front angle α₄ and the back angle α₅ is between about two degrees and about 10 degrees. In certain embodiments, the difference between the front angle α₄ and the back angle α₅ is about six degrees. For the angled connector 828 to be used in a typical stairway application, the included angle α₃ may be about 32 degrees, the front angle α₄ may be about 29 degrees, and the back angle α₅ may be about 35 degrees. Other included, front, and back angles are contemplated. For example, for an ADA compliant ramp, the included angle α₃ may be about five degrees, the front angle α₄ may be about three degrees, and the back angle α₅ may be about seven degrees.

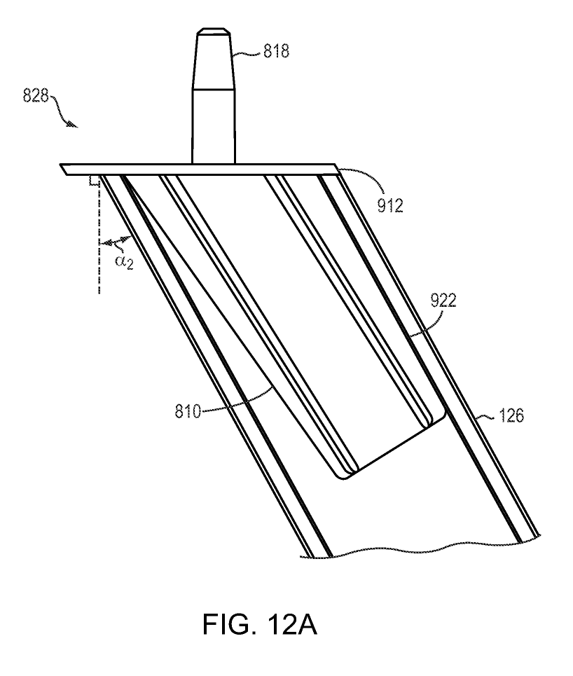

FIG. 11 is a perspective view of the angled connector 828, in accordance with one embodiment of the present invention. As depicted, the front face 922 and/or the back face 924 may include or be defined by one or more plug ridges 814. In some embodiments, the plug ridges 814 extend from the plug base 918 to the plug end 920. When the plug portion 810 is inserted into the baluster 126, the front face 922, back face 924, or outer surfaces of the plug ridges 814 (if present) may contact interior wall surfaces of the baluster 126.

In many applications, due to imperfections in stairway or ramp components and/or installation, design tolerances, or other design constraints, the installed rail angle α₂ may deviate from the anticipated or nominal ramp angle α₁. For example, while most stairways have a nominal ramp angle α₁ of 32 degrees, the actual ramp angle α₁ for any given stairway may deviate from that nominal angle, and this may cause a corresponding deviation in rail angle α₂. As a result, once upper and lower rails 114, 120 are installed, the actual rail angles α₂ may range from, for example, about 29 degrees to about 35 degrees. Despite such deviations in the rail angle α₂, it is desirable to use a connector that allows the balusters 126 to be installed in a vertically aligned orientation. Accordingly, the angled connector 828 of the present invention incorporates novel dimensional relationships to allow for vertical baluster alignment, regardless of rail angle α₂, within the design range of the connector 828.

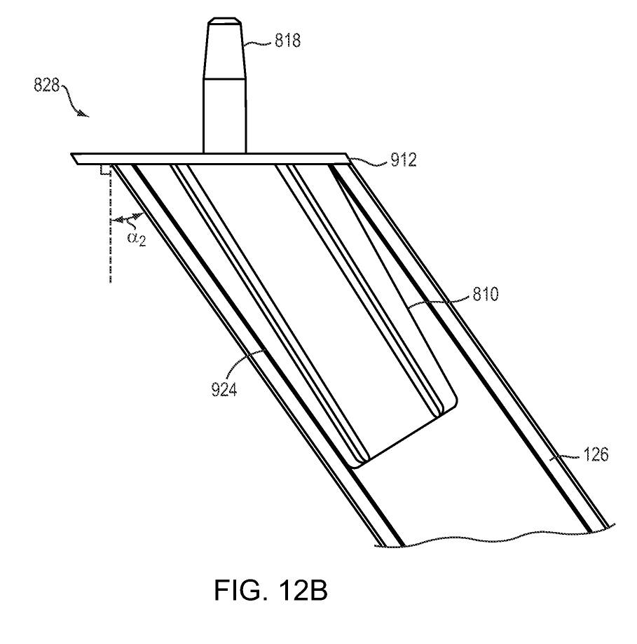

FIGS. 12A and 12B are side views of the angled connector 828 installed in a baluster 126, in accordance with one embodiment of the present invention. As depicted, by providing tapered plug portion 810, balusters 126 may be vertically installed despite deviations in the rail angle α₂. For example, the angled connector 828 to be used for an installation may have an included angle α₃ equal to the nominal rail angle α₂, a front angle α₄ that is three degrees less than the included angle α₃, and a back angle α₅ that is three degrees greater than the included angle α₃, resulting in a three degree taper angle on the front and back of the plug portion 810. Referring to FIG. 12A, when the installed rail angle α₂ is equal to the front angle α₄, the front face 922 of the plug portion 810 is in contact with or substantially parallel to a front wall of the baluster 126. In such an installation, the baluster 126 is still oriented vertically, even though the rail angle α₂ deviated from the nominal angle by three degrees. Additionally, due to the taper in the plug portion 810, this deviation may be addressed without modifying the angled connector 828, or using an angled connector 828 with a different included angle α₃. Similarly, referring to FIG. 12B, when the installed rail angle α₂ is equal to the back angle α₅, the back face 924 of the plug portion 810 is in contact with or substantially parallel to a back wall of the baluster 126. Any rail angle α₂ between the front angle α₄ and the back angle α₅ could also be accommodated using the same angled connector 828, although in those instances the front face 922 and/or back face 924 would likely not be parallel with the front wall or back wall of the baluster 126. In this particular embodiment, the installed rail angle α₂ may deviate by about three degrees on either side of the nominal rail angle α₂, but the tapered plug portion 810 still allows for vertical installation of the balusters 126 with use of the same angled connector 828.

For a typical stairway railing system 700 installation, the angled connector 828 may be designed so that the included angle α₃ is approximately equal to the nominal ramp angle α₁ of the ramp or stairway. For example, if the ramp angle α₁ is anticipated to be 32 degrees, as used in many stairway applications, then angled connectors 828 having an included angle α₃ of about 32 degrees may be utilized. As another example, if the ramp angle α₁ is anticipated to be about five degrees, as is typical for many wheelchair ramp applications, then angled connectors 828 having an included angle α₃ of about five degrees may be used. Front and back angles α₄, α₅ may also deviate from the include angle α₃ by about one degree to about 10 degrees, about two degrees to about eight degrees, and about three degrees to about six degrees. Other deviations are also contemplated. As is apparent from the above disclosure, the greater the deviation of the front or back angles α₄, α₅ from the included angle α₃, the greater the range of rail angle α₂ deviation that may be accommodated. The baluster ends may be trimmed, if desired, to mate closely with the shoulder element 912.

While the stairway railing system 700 may be installed using the assembly method 600 described above and depicted in FIG. 6, additional assembly methods are contemplated. For example, in one embodiment, assembly begins by securing the bottom rail 120 to posts 110 located near the top and bottom of a flight of stairs. The projections 818 of the angled connectors 828 are then inserted into the lower rail 120 and the lower ends of the balusters 126 are inserted over the plug portions 810 of the angled connectors 828. Next, the projections 818 of additional angled connectors 828 are inserted into the upper rail 114. The upper rail 114 is then positioned above top ends of the installed balusters 126 and the plug portions 810 of the upper angled connectors 828 are inserted into the tops of the balusters 126. As a final step, the upper rail 114 is secured to the posts 110.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A connector for attaching a hollow baluster to a hollow rail in a railing system, the connector comprising:
a first section adapted to be received in an aperture formed in an end of the hollow baluster; and
a second section adapted to be received in an aperture formed through a wall of the hollow rail, the second section comprising at least one resilient tab configured to engage an interior surface of the hollow rail when received therein.

2. The connector of claim 1, wherein the second section is sized and configured to preclude rotation of the connector relative to the rail when received therein.

3. The connector of claim 2, wherein the second section comprises at least one projection, wherein the projection comprises a width and a thickness, wherein the width is greater than the thickness.

4. The connector of claim 1, wherein the resilient tab comprises a unitary part comprising two tines, each tine comprising a shoulder.

5. The connector of claim 4, wherein the tines comprise a first, unstressed position and a second, deflected position.

6. The connector of claim 5, wherein the shoulders contact an interior surface of the hollow rail when the tines are in the first, unstressed position.

7. The connector of claim 1, wherein the first section comprises at least one raised ridge.

8. The connector of claim 7, wherein the connector comprises at least one side surface and wherein the raised ridge projects from the side surface.

9. The connector of claim 8, wherein the raised ridge interacts with an interior surface of the hollow baluster, so as to form an interference fit between the baluster and the connector.

10. A method of assembling a railing system comprising a first post, a second post, a hollow lower rail, a hollow upper rail, and a hollow baluster, the method comprising the steps of:
providing a first connector comprising:
a first section; and
a second section comprising at least one resilient tab;
inserting the first section of the connector into the hollow baluster; and
inserting the second section of the connector into an aperture formed in a wall of the hollow lower rail, so as to engage the resilient tab with an interior surface of the hollow lower rail.

11. The method of claim 10, further comprising the steps of:
providing a second connector comprising:
a first section; and
a second section comprising at least one resilient tab;
inserting the first section of the second connector into the hollow baluster; and
inserting the second section of the second connector into an aperture formed in a wall of the hollow upper rail, so as to engage the resilient tab of the second connector with an interior surface of the hollow upper rail.

12. The method of claim 11, further comprising the step of securing a first end of the hollow upper rail to the first post with a first upper bracket.

13. The method of claim 12, further comprising the step of securing a second end of the hollow upper rail to the second post with a second upper bracket.

14. The method of claim 13, further comprising the step of securing a first end of the hollow lower rail to the first post with a first lower bracket.

15. The method of claim 14, further comprising the step of securing a second end of the hollow lower rail to the second post with a second lower bracket.

16. A connector for attaching a hollow baluster to a hollow rail in an angled railing system, the connector comprising:
a projection defining a first longitudinal axis and adapted to be received in an aperture defined by a wall of a hollow rail; and
a plug portion fixed to the projection, the plug portion defining a second longitudinal axis and adapted to be received in an aperture formed in an end of a hollow baluster, wherein the first longitudinal axis is not collinear with the second longitudinal axis.

17. The connector of claim 16, wherein the first longitudinal axis and the second longitudinal axis form an included angle.

18. The connector of claim 17, wherein the included angle is from about 2° to about 45°.

19. The connector of claim 18, wherein the included angle is from about 29° to about 35°.

20. The connector of claim 19, wherein the included angle is about 32°.

21. The connector of claim 17, wherein the plug portion comprises a front face and a back face, and wherein the front face is oriented at a front angle comprising an angle between the front face and an axis parallel to the first longitudinal axis, and the back face is oriented at a back angle comprising an angle between the back face and an axis parallel to the first longitudinal axis.

22. The connector of claim 21, wherein the front angle and the back angle are from about 2° to about 35°.

23. The connector of claim 21, wherein the front angle is less than the back angle.

24. The connector of claim 21, wherein each of the front angle and the back angle deviate from the included angle by about 3°.

25. The connector of claim 16, wherein the plug portion further comprises a side wall surface projecting in a direction substantially parallel to the first longitudinal axis.

26. The connector of claim 25, wherein the side wall surface comprises a crush rib.

27. The connector of claim 16, further comprising an enlarged shoulder element located between the projection and the plug portion.
